(19) United States
(12) Patent Application Publication
(10) Pub. No.: US 2013/0095008 A1
(43) Pub. Date: Apr. 18, 2013

(54) TUBE AND FLOAT SYSTEMS AND METHODS OF USING THE SAME

(71) Applicant: RareCyte, Inc., Seattle, WA (US)

(72) Inventors: Jackie Lynn Stilwell, Sammamish, WA (US); Arturo Ramirez, Seattle, WA (US); Joshua Nordberg, Bainbridge Island, WA (US); Barry Friemel, Redmond, WA (US)

(73) Assignee: RareCyte, Inc., Seattle, WA (US)

(21) Appl. No.: 13/709,501

(22) Filed: Dec. 10, 2012

Related U.S. Application Data
(63) Continuation-in-part of application No. 13/565,104, filed on Aug. 2, 2012.
Application No. 13/565,104 is a continuation-in-part of application No. 13/437,616, filed on Apr. 2, 2012.
(60) Provisional application No. 61/569,584, filed on Dec. 12, 2011.
(60) Provisional application No. 61/514,102, filed on Aug. 2, 2011.
(60) Provisional application No. 61/577,866, filed on Dec. 20, 2011.

(51) Int. Cl. B01D 15/20

(52) U.S. Cl. CPC B01D 15/206
USPC 422/533

(57) ABSTRACT

This disclosure is directed to systems for analyzing target materials of a suspension. In one aspect, the systems include a tube and a float that is at least partially coated with a coating having a high affinity for target analytes of a suspension. The coating provides an adhesion or an attraction force with the target analytes through chemical means. In another aspect, the coating can be a changeable material that when stimulated by application of an appropriate stimulus attracts and/or attaches the target analytes to the coated surface of the float. In another aspect, a coating applied to the float may also be used to form a sealing engagement between the float and the inner surface of the tube in order to inhibit fluids from flowing past the coated float in the tube.

### CROSS-REFERENCE TO A RELATED APPLICATION

This application claims the benefit of Provisional Application No. 61/569,584, filed Dec. 12, 2011, and is a continuation-in-part of Application No. 13/565,104, filed Aug. 2, 2012, which claims the benefit of Provisional Application No. 61/514,102, filed Aug. 2, 2011, which is a continuation-in-part of Application No. 13/437,616, filed Apr. 2, 2012, which claims the benefit of Provisional Application No. 61/577,866, filed Dec. 20, 2011.

### TECHNICAL FIELD

This disclosure relates generally to density-based fluid separation and, in particular, to tube and coated float systems for the separation and axial expansion of constituent suspension components layered by centrifugation.

### BACKGROUND

Suspensions often include materials of interest that are difficult to detect, extract and isolate for analysis. For instance, whole blood is a suspension of materials in a fluid. The materials include billions of red and white blood cells and platelets in a proteinaceous fluid called plasma. Whole blood is routinely examined for the presence of abnormal organisms or cells, such as fetal cells, endothelial cells, epithelial cells, parasites, bacteria, and inflammatory cells, and viruses, including HIV, cytomegalovirus, hepatitis C virus, and Epstein-Barr virus and nucleic acids. Currently, practitioners, researchers, and those working with blood samples try to separate, isolate, and extract certain components of a peripheral blood sample for examination. Typical techniques used to analyze a blood sample include the steps of smearing a film of blood on a slide and staining the film in a way that enables certain components to be examined by bright field microscopy.

On the other hand, materials of interest composed of particles that occur in very low numbers are especially difficult if not impossible to detect and analyze using many existing techniques. Consider, for instance, circulating tumor cells (“CTCs”), which are cancer cells that have detached from a tumor, circulate in the bloodstream, and may be regarded as seeds for subsequent growth of additional tumors (i.e., metastasis) in different tissues. The ability to accurately detect and analyze CTCs is of particular interest to oncologists and cancer researchers, but CTCs occur in very low numbers in peripheral whole blood samples. For instance, a 7.5 ml sample of peripheral whole blood that contains as few as 3 CTCs is considered clinically relevant in the diagnosis and treatment of a cancer patient. However, detecting even 1 CTC in a 7.5 ml blood sample may be clinically relevant and is equivalent to detecting 1 CTC in a background of about 40-50 billion red and white blood cells. Using existing techniques to find, isolate and extract as few as 3 CTCs of a whole blood sample is extremely time consuming, costly and is extremely difficult to accomplish.

As a result, practitioners, researchers, and those working with suspensions continue to seek systems and methods to more efficiently and accurately detect, isolate and extract target materials of a suspension.

### DESCRIPTION OF THE DRAWINGS

FIGS. 1A-1B show isometric views of two example tube and coated float systems.

FIG. 2A shows an example of a coated float.

FIGS. 2B-2C show examples of coated floats.

FIGS. 3-5 show examples of coated floats with different structural elements.

FIGS. 6A-6D show examples of coated floats.

FIG. 7A shows an example of a tube and coated float system used to trap a target analyte.

FIG. 7B shows an example of a tube and coated float system used to trap a target analyte.

FIGS. 8A-8B show examples of tube and coated float systems that form a sealing engagement between the tube and the coated float.

### DETAILED DESCRIPTION

This disclosure is directed to systems for analyzing target materials of a suspension. In one aspect, the systems include a tube and a float that is at least partially coated with a coating having a high affinity for target analytes of a suspension. The coating provides an adhesion or an attraction force with the target analytes through chemical means. In another aspect, the coating can be a changeable material that when stimulated by application of an appropriate stimulus attracts and/or attaches the target analytes to the coated surface of the float. In another aspect, a coating applied to the float may also be used to form a sealing engagement between the float and the inner surface of the tube in order to inhibit fluids from flowing past the coated float in the tube.

The detailed description is organized into two subsections: A general description of tube and coated float systems is provided in a first subsection. Methods for using tube and coated float systems are provided in a second subsection.

### General Description of Tube and Coated Float Systems

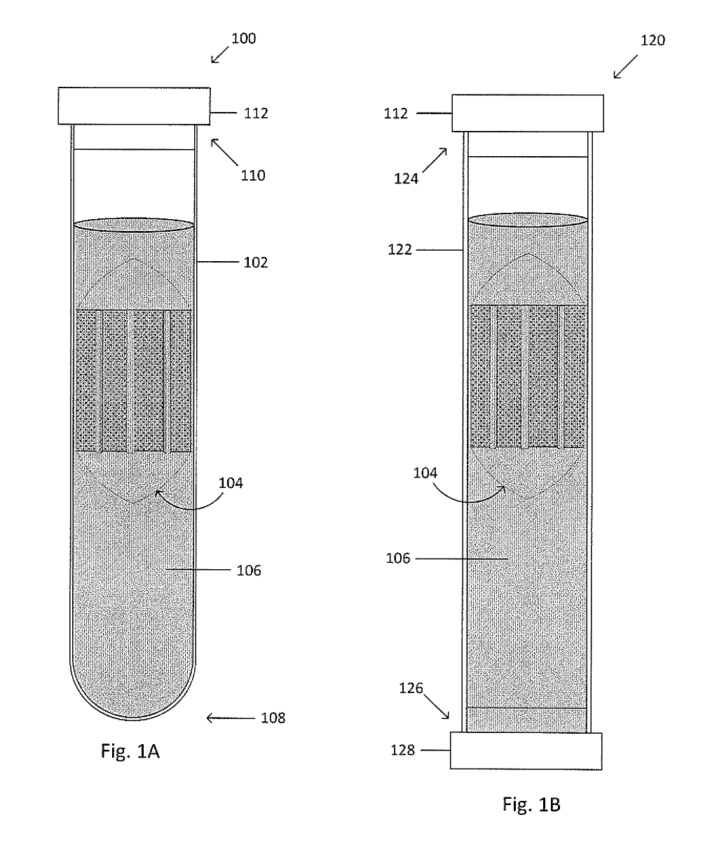

FIG. 1A shows an isometric view of an example tube and coated float system 100. The system 100 includes a tube 102 and a coated float 104 suspended within a suspension 106. In the example of FIG. 1A, the tube 102 has a circular cross-section, a first closed end 108, and a second open end 110. The open end 110 is sized to receive a stopper or cap 112. The tube may also have two open ends that are sized to receive stoppers or caps, such as the example tube and coated float system 120 shown FIG. 1B. The system 120 is similar to the system 100 except the tube 102 is replaced by a tube 122 that includes two open ends 124 and 126 configured to receive the cap 112 and a cap 128, respectively. The tubes 102 and 122 have a generally cylindrical geometry, but may also have a tapered geometry that widens, narrows, or a combination thereof toward the open ends 110 and 124, respectively. Although the tubes 102 and 122 have a circular cross-section, in other embodiments, the tubes 102 and 122 can have elliptical, square, triangular, rectangular, octagonal, or any other suitable cross-sectional shape that substantially extends the length of the tube. The tubes 102 and 122 can be composed of a transparent or semitransparent flexible material, such as flexible plastic or another suitable material. The tube may also include a plug (not shown) at the closed end 108 to permit the removal of a fluid, the suspension, or a suspension fraction, whether with a syringe, a pump, by draining, or the like.

The tube 102 has a radially expandable sidewall with a natural first diameter. The coated float 104 can be captured within the tube 102 by an interference fit. In order to remove the coated float 104 from the tube 102 after the coated float 104 has been captured, or inserted into the tube 102, the expandable sidewall can be expanded radially to a larger diameter by applying an axial load, such as axial pressure due to centrifugation, external vacuum, or internally-introduced pressure. The larger diameter is sufficiently large to permit axial movement of the coated float 104 in the tube 102 during centrifugation.

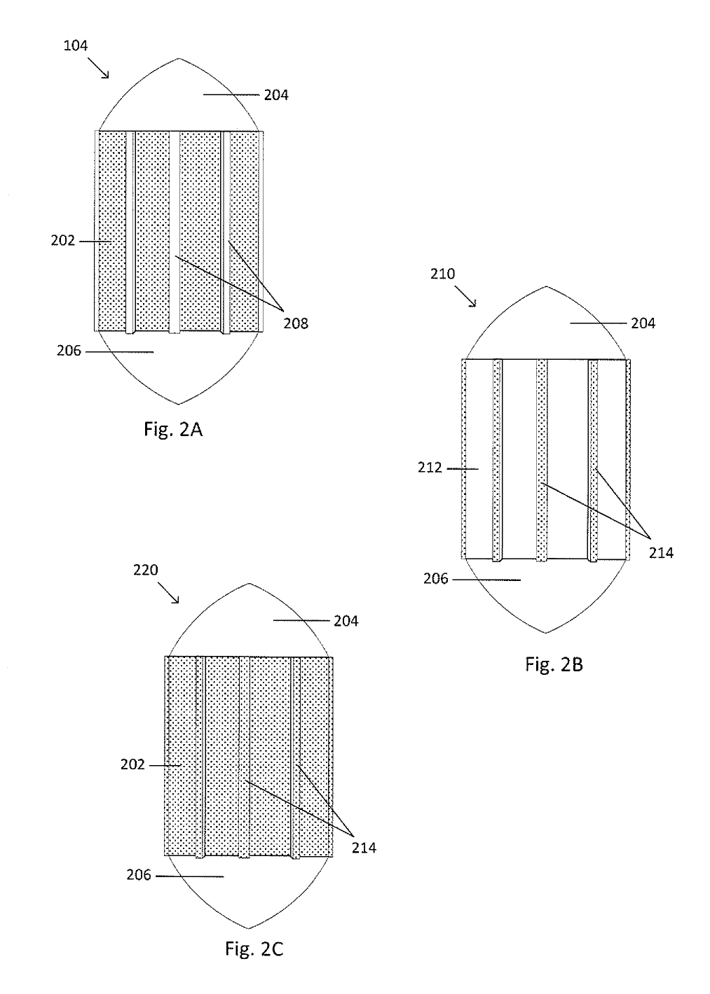

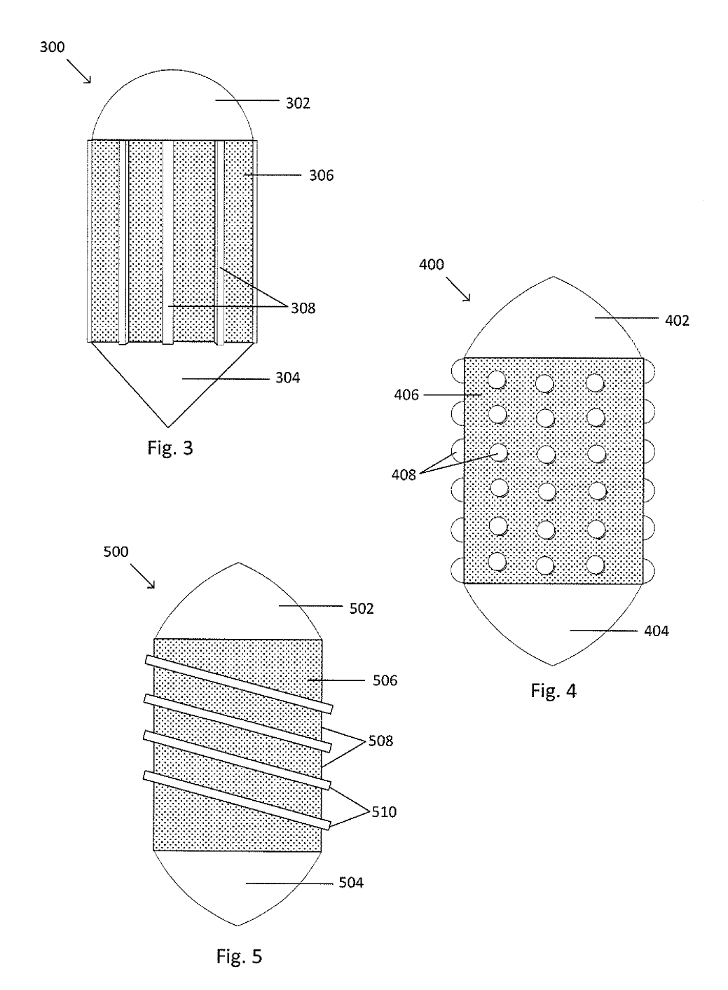

FIG. 2A shows an isometric view of the coated float 104 shown in FIG. 1. The coated float 104 includes a coated main body 202, two teardrop-shaped end caps 204 and 206, and raised structural elements 208 radially spaced and axially oriented on the main body 202. The coated float 104 can also include two dome-shaped end caps, two cone-shaped end caps, or the end caps can have any appropriate shape or geometry. The raised structural elements 208 extend outward from the main body 202 to engage the inner wall of the tube 102.

In alternative embodiments, the number of raised structural elements, raised structural element spacing, and raised structural element thickness can each be independently varied. The raised structural elements 208 can also be broken or segmented. The coated main body 202 is sized to have an outer diameter that is less than the inner diameter of the tube 102, thereby defining fluid retention channels between the outer surface of the coated main body 202 and the inner wall of the tube 102. The surfaces of the coated main body 202 between the raised structural elements 208 can be flat, curved or have another suitable geometry. In the example of FIG. 2A, the raised structural elements 208 and the main body 202 form a single structure.

The coating can cover the entire main body 202, a portion of the main body 202, or many portions of the main body 202. FIG. 2B shows an isometric view of a coated float 210. The coated float 210 is similar to the coated float 104 except the main body 212 is not coated, whereas the raised structural elements 214 are coated. FIG. 2C shows an isometric view of a coated float 220. The coated float 220 is similar to the coated float 104 except both the main body 202 and the raised structural elements 214 are coated.

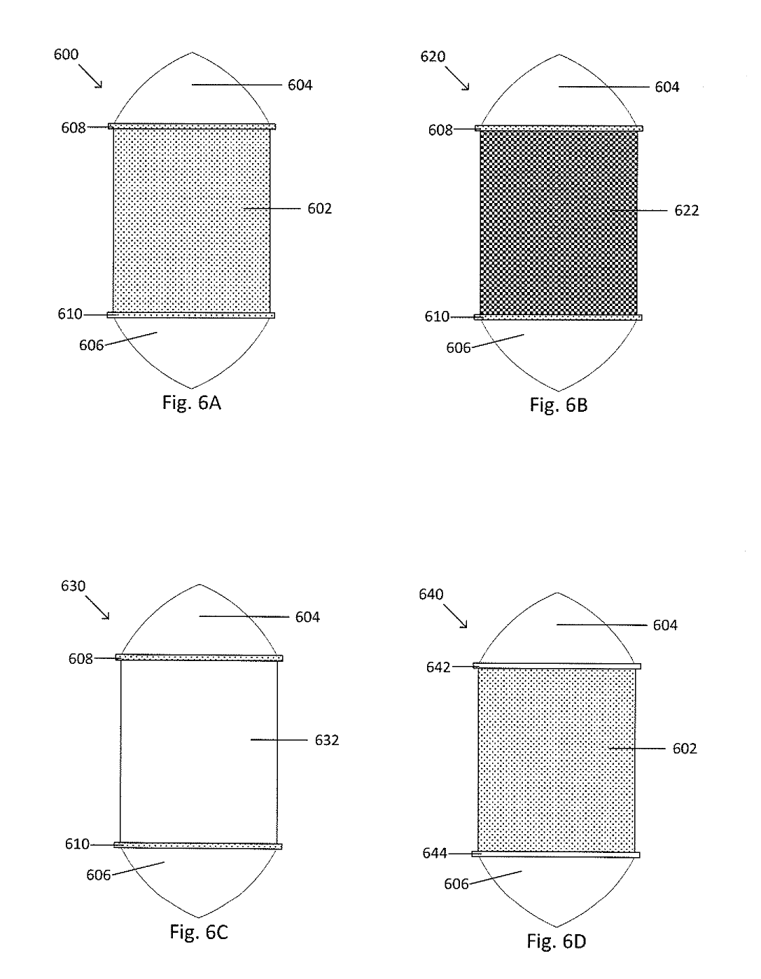

Embodiments include other types of geometric shapes for end caps. FIG. 3 shows an isometric view of an example coated float 300 with a dome-shaped end cap 302 and a cone-shaped end cap 304. A coated main body 306 of the coated float 300 can include the same raised structural elements 308 as the coated float 104. A coated float can also include a teardrop-shaped end cap. The coated float end caps can include other geometric shapes and are not intended to be limited to the shapes described herein.

In other embodiments, the main body of the coated float 104 can include a variety of different raised structural elements for separating target materials, supporting the tube wall, or directing the suspension fluid around the coated float during centrifugation. FIGS. 4 and 5 show examples of two different types of raised structural elements. Embodiments are not intended to be limited to these two examples. In FIG. 4, a coated main body 406 of a coated float 400 is similar to the coated float 104 except the coated main body 406 includes a number of protrusions 408 that provide support for the tube. In alternative embodiments, the number and pattern of protrusions can be varied. In FIG. 5, a coated main body 506 of a coated float 500 includes a single continuous helical structure or ridge 510 that spirals around the coated main body 506 creating a helical channel 508. In other embodiments, the helical ridge 510 can be rounded or broken or segmented to allow fluid to flow between adjacent turns of the helical ridge 510. In various embodiments, the helical ridge spacing and rib thickness can be independently varied.

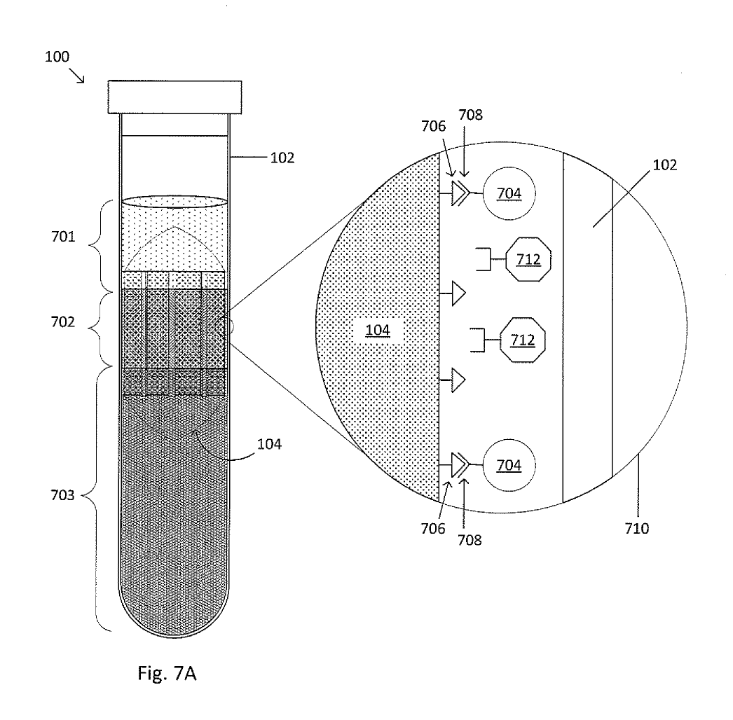

FIG. 6A shows an isometric view of a coated float 600. The coated float 600 includes a coated main body 602, two teardrop-shaped end caps 604, 606, and sealing structural elements 608 and 610 extending circumferentially around the coated main body 602. The sealing structural elements 608 and 610 provide sealing engagements with the inner wall of the tube 102. The coating can cover the entire main body 602, a portion of the main body 602, or different portions of the main body 602. One of the sealing structural elements 608 and 610 can be omitted.

The coated float 600 may also include one or more raised structural elements (not shown) on the main body 602, the raised structural element (not shown) may be vertical, horizontal, or at least one helical ridge that spiral around the main body 602, or any appropriate raised structural element shape or configuration. The top sealing structural element 608 and the bottom sealing structural element 610 may be extensions of the main body 602, thereby extending horizontally outward beyond the main body 602. Alternatively, the top sealing structural element 608 and the bottom sealing structural element 610 may be extensions of the main body 602 or top and bottom end caps 604 and 606. The coating can be layered over the sealing structural elements 608 and 610 to further augment engagement with the inner wall of a tube. The top and bottom end caps can be teardrop-shaped, dome-shaped, cone-shaped, or any other appropriate shape.

FIG. 6B shows an isometric view of a coated float 620. The coated float 620 is similar to the coated float 600 except the main body 622 has a coating different than the coating applied to the sealing structural elements 608 and 610. FIG. 6C shows an isometric view of a coated float 630. The coated float 630 is similar to the coated float 600 except the sealing structural elements 608 and 610 are coated and the main body 632 is not coated. FIG. 6D shows an isometric view of a coated float 640. The coated float 640 is similar to the coated float 600 except the sealing structural elements 642 and 644 are not coated and the main body 602 is coated.

A coating is selected to increase the affinity of the coated float for a target analyte. By increasing the affinity through mechanisms such as adhesion and chemical attraction or bonding, the coated float retains the target analyte, thereby reducing the number of target analytes that can be lost through subsequent processing, such as by washing. The affinity between the coating and the target analyte results in a strong and/or secure attachment of the target analyte to the coated surface of a coated float. By attaching the target analyte to the float via the coating, enables the target analyte to be properly fixed, permeabilized, and stained. The enhanced holding of the target analytes to the coating decreases or eliminates the risk of target analytes being washed away.

The coating can also allow for higher efficiency of intracellular analysis because more target analytes can be retained prior to the steps of fixing, permeabilizing, and staining. This permits the target analytes to be properly held prior to use of a chemical fixative, such as formalin. The attraction or adhesion of the coating provides a more uniform method to hold the target analytes, thereby reducing or eliminating the inconsistencies and deficiencies that are typically associated with using the chemical fixative because of the insufficient flow and coverage of the chemical fixative with a flow-through method.

The coating may be any material that either attracts the target analyte and forms a chemical bond with the target analyte or causes the target analyte to adhere to the coated float without chemically altering the target analyte (i.e. the coating acts as an adhesive). The coating may also bond with a molecule on the target analyte that, through pre-processing, was attached to the target analyte prior to introducing the target analyte to the coated float. Different types of coatings can be selected or designed to increase the affinity of the target analyte for the coated through different mechanisms. When the coating is selected to attract the target analyte and form a chemical bond with the target analyte, the bond may be covalent, ionic, dipole-dipole interactions, electrostatic, hydrophobic-hydrophilic interaction, London dispersion forces, van der Waal's forces, adhesion, hydrogen bonding, or any other bond. Examples of such coating include, but are not limited to, maleic anhydride; maleimide activated sulfa-hydryl groups; poly-L-lysine; poly-D-lysine; an avidin, such as streptavidin or neutravidin; protein A, protein G, protein A/G, protein L; biotin; glutathione; recombinant antibodies; aptamers, including 3D aptamers; RGD-peptides; fibronectin; collagen; elastin; fibrillin; laminin; proteoglycans; a primary antibody that binds to biomarkers, including but not limited to, EpCAM, AMACR, Androgen receptor, CD146, CD227, CD235, CD24, CD30, CD44, CD45, CD56, CD71, CD105, CD324, CD325, MUC1, CEA, cMET, EGFR, Folate receptor, HER2, Mammaglobin, PSMA; or combinations thereof. The coating may also include, but is not limited to, proteins, such as CD24, CD44, CEA, and PCLP; P-selectin, such as PSEL-1, or E-selectin; any variation of Mytilus edulis foot protein (“Mefp”); biopolymers; or polyphenolic proteins (including those polyphenolic proteins containing L-DOPA).

The coating may also be any changeable material, such as convertible, activatable or releasable, in response to an appropriate stimulus to hold the target analyte to the coating of the coated float (i.e. photo-convertible adhesive) or to form a seal between the coated float and the tube. When the coating comprises a changeable material, the coating can be changed from a non-functional state to a functional state by application of an appropriate stimulus. The stimulus can be thermal (e.g., change in temperature), chemical (e.g., change in pH), electrical (e.g., application of a current or voltage), electrochemical, electromagnetic, acoustic (e.g. sound energy), light, and optical, such as a laser or a solid-state diode. For example, the coating can be a photo-convertible material that changes the photo-convertible material into a material that attaches the target analyte when illuminated with light in a range of wavelengths. In particular, an ultraviolet light source, such as an ultraviolet light source that emits light with a wavelength of approximately 355 nm, can be used to induce a chemical reaction in a photo-convertible material that forms a covalent bond between the material and the target analyte. When the coating comprises a releasable material, such as nano-encapsulated molecules, a secondary material is released from the releasable material or the releasable material itself may be released from the coating, such that the secondary material or the releasable material attaches the target analyte to the coated float. The secondary material or releasable material may include fixing agents (e.g., formaldehyde, formalin, paraformaldehyde, or glutaraldehyde), detergents (e.g., saponin, polyoxyethylene, digitonin, octyl β-glucoside, octyl β-thioglucoside, 1-S-octyl-β-D-thioglucopyranoside, CHAPS, CHAPSO, (1,1,3,3-Tetramethylbutyl)phenyl-polyethylene glycol or octylphenol ethylene oxide), or staining agents (e.g., fluorescently-labeled antibodies, Pap stain, Giemsa stain, or hematoxylin and eosin stain).

The coating may also include epidermal growth factor (“EGF”), vascular endothelial growth factor (“VEGF”), an extracellular matrix (“ECM”) protein, or another chemo-attractant molecule. Chemo-attractant molecules elicit a chemotaxis response from a target analyte, whereby the target analyte is attracted to the chemo-attractant molecules. Chemotaxis is an active movement of the target analyte due to a chemical or chemicals present in the environment. The EGF, VEGF, chemo-attractant molecule, or ECM may be used as a layer, either alone or in conjunction with a material discussed above. Furthermore, the EGF, VEGF, chemo-attractant molecule, or ECM may be mixed together to form a one layer coating on the outer surface of the coated float. The EGF, VEGF, chemo-attractant molecule, or ECM, when used in combination with one of the other coatings discussed above, may be a sub-layer in which it is layered between the coated float and the other coating or may be the coating where one or the other materials discussed above is the sub-layer. The coating may also be a mixture of the EGF, VEGF, chemo-attractant molecule, or ECM with one of the materials discussed above. The coating of EGF, VEGF, chemo-attractant molecule, or ECM can cause the target analyte to migrate to the coated float, where the target analyte is trapped and held by one of the other coatings disclosed. When the coating of EGF, VEGF, chemo-attractant molecule, or ECM is used separately, the coating may simply be more attractive to the target analyte than other surfaces within the tube and coated float system.

The coatings discussed above may be selected, designed, or developed in such a way that the coating selectively attracts and holds the target analyte without holding or attracting any other analyte, particle, or portion of the suspension. The selective adhesion of the coatings allow for enhanced fixing, permeabilizing, and staining. The target analytes are attracted and held to the coating, but any non-target particles present are not attracted to or held and may be washed away. Since only the target analytes remain, the target analytes can be fixed, permeabilized, and stained without concern for non-selective staining, whereby the non-target particles may have been detected as well. For example, the target analyte can represent a circulating tumor cell (“CTC”). CTCs are cancer cells that have detached from a primary tumor, circulate in the bloodstream, and may be regarded as seeds for subsequent growth of tumors (i.e., metastasis) in different tissues.

### Methods for Using Tube and Coated Float Systems

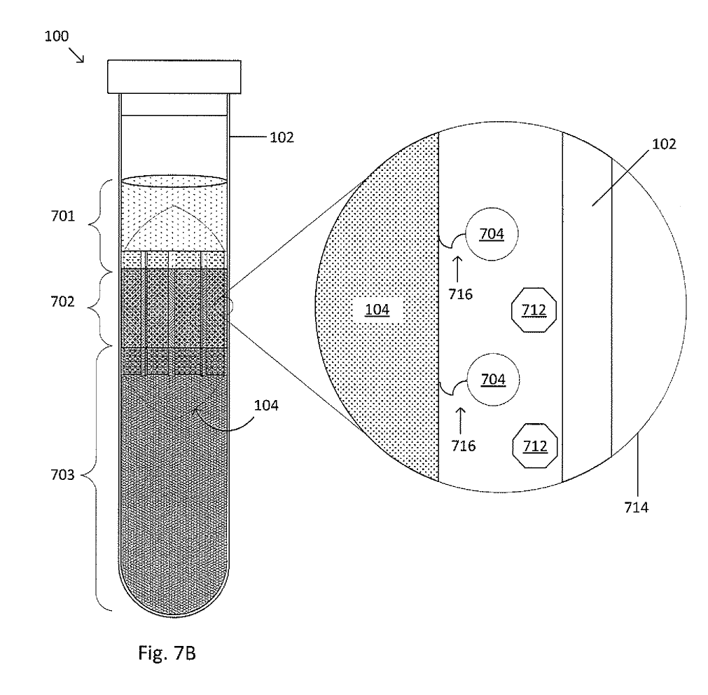

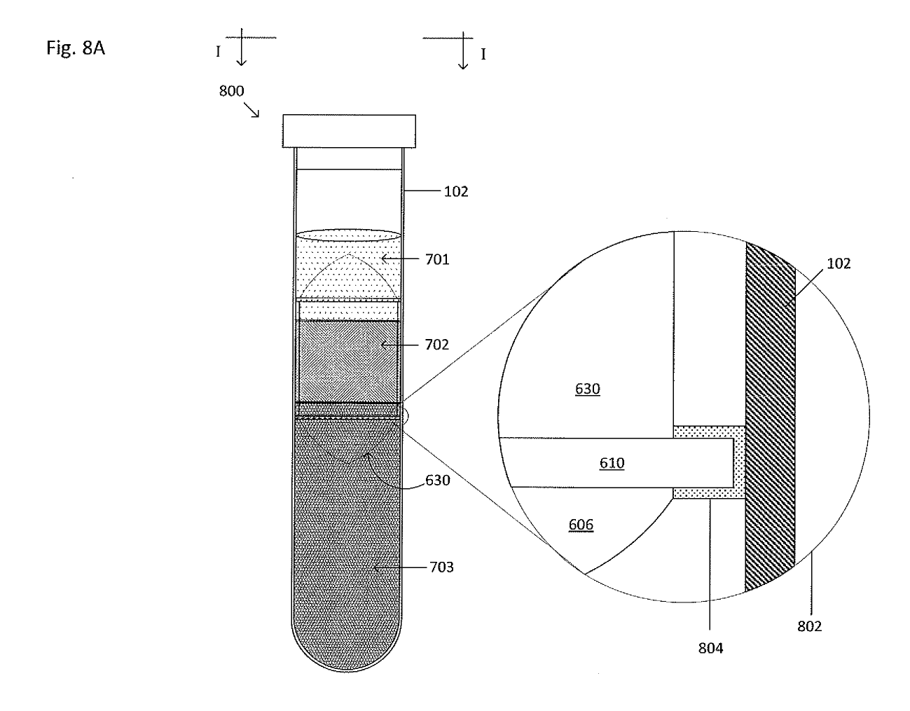

FIG. 7A shows an isometric view of a tube and coated float system 100 having undergone density-based separation, such as by centrifugation. A magnified view 710 is also included which shows the interaction between a coating on the coated float 104 and a target analyte 704. Suppose, for example, the suspension includes three fractions. During centrifugation, the suspension may be divided into and separated into the three fractions, including a high density fraction 703, a medium density fraction 702, and a low density fraction 701. The target analyte 704 may be found in the medium-density fraction 702. The coated float 104 may have a density substantially similar to that of the target analyte 704, so that the coated float 104 and the target analyte 704 align properly within the tube 102.

The magnified view 710 shows the coated float 104 trapping target analytes 704. The coating includes a molecule 706 that selectively binds to a complementary molecule 708 of the target analyte 704. The non-target analyte 712, however, does not possess the complementary molecule 708, and therefore does not bind to the coating, and ultimately to the coated float 104. For example, the coating may be or may include an EpCAM antibody. The EpCAM antibody binds to an EpCAM protein, which can be present on the target analyte but is not present on a non-target analyte. The EpCAM antibody and the EpCAM protein, being complementary in nature, bind together, thereby attaching the target analyte to the coating of the coated float. The non-target analyte does not bind to the coating, because the non-target analyte does not include the complementary EpCAM protein.

FIG. 7B shows an isometric view of a tube and coated float system 100 having undergone density-based separation, such as by centrifugation. A magnified view 714 is also included which shows the interaction between a coating on the coated float 104 and the target analyte 704. The magnified view 714 shows the target analyte 704 trapped between the coated float 104 the wall of the tube 102. The coating includes a molecule 716 that attracts the target analyte 704. The non-target analyte 712, however, is not attracted to the molecule 716 and, therefore, does not bind to the coating, and ultimately does not bind to the coated float 104. For example, the coating may be epidermal growth factor (“EGF”). The EGF attracts the target analyte, thereby trapping the target analyte to the coating of the coated float, but does not attract the non-target analyte. The non-target analyte is not attached to the coating, because the non-target analyte is not attracted to the EGF. As another example, the coating can adhere the target analyte, such as Mytilus edulis foot protein (“Mefp”), such that the target analytes are held to the coated float through adhesion.

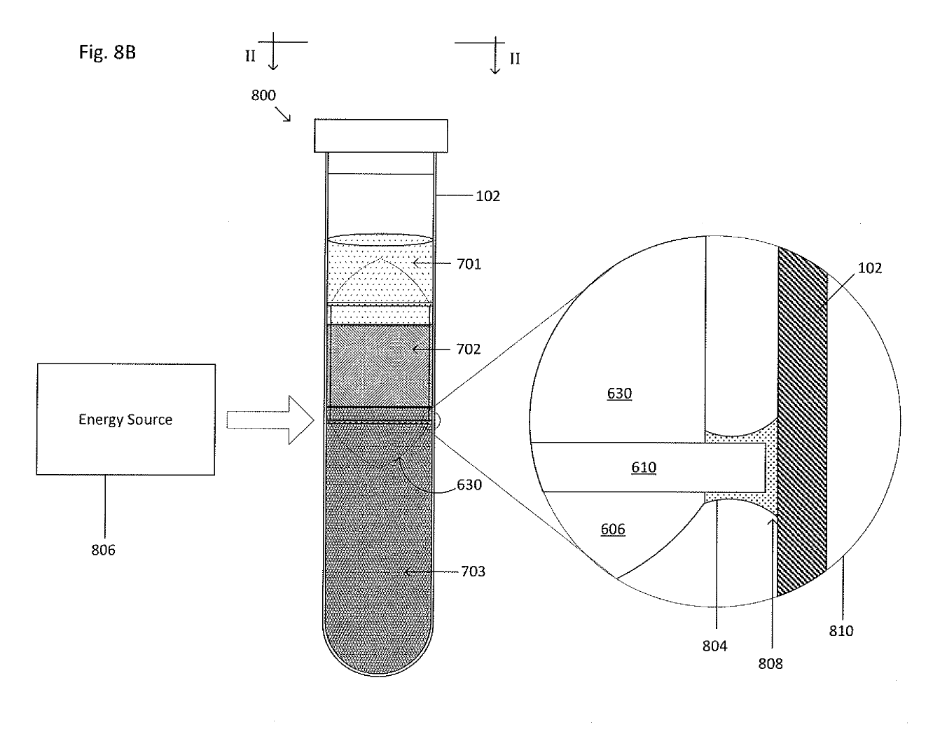

FIG. 8A shows an isometric view of a tube and coated float system 800 having undergone density-based separation, such as by centrifugation. After centrifugation, a coated float 630 is captured within the tube 102 by the structural element 610. Magnified view 802 shows a cross-section view taken along line I-I of the coated float 630 engaging a sidewall of the tube 102 at a capture point. The structural element 610 includes a coating 804 that forms a ring-shaped seal between the structural element 610 and the inner surface of the tube 102. The seal occurs where the structural element 610, including the coating 804, engages the sidewall of the tube 102.

FIG. 8B shows an isometric view of the tube and coated float system 800 after an energy source 806 has introduced energy into the system. Snapshot 810 shows a cross-section view taken along line II-II of the formation of a seal 808 at the capture point. The energy source 806 emits energy, different than the energy introduced during imaging, to convert or activate the coating to trigger a reaction, thereby causing the material to reach a functional state, thereby forming the seal 808 by adhesion, fusion, or the like between the sealing structural element 610 and the tube 102 at the capture point. Alternatively, the coating may be a band or a segment on the main body which can form a seal between the coated float and the tube by adhesion, fusion, or the like upon conversion or activation of the coating. The seal 808 inhibits fluids from flowing past the coated float 630 in the tube 102. It should be noted, however, that the seal 808 is created after a suspension has undergone density-based separation. The seal 808 may also be formed when the coating is an adhesive, such that when the coated float 630 is captured by the tube 102, the coated float 630 adheres to the tube 102 at the capture point.

The target analyte may have a number of different types of receptor molecules located on the surface. Each type of receptor is a molecule capable of attaching a particular ligand. As a result, ligands can be used to classify the target particles and determine the specific type of target particles present in the suspension by conjugating ligands that attach to particular receptors with a particular fluorescent probe. For example, each type of fluorescent probe emits light in a narrow wavelength range of the electromagnetic spectrum called a “channel” when an appropriate stimulus, such as light with a shorter wavelength, is applied. A first type of fluorescent probe that emits light in the green channel can be attached to a first ligand that binds specifically to a first type of receptor, while a second type of fluorescent probe that emits light in the red channel can be attached to a second ligand that binds specifically to a second type of receptor. The channel color observed as a result of stimulating the target material identifies the type of receptor, and because receptors can be unique to particular target particles, the channel color can also be used to identify the target particle. Examples of suitable fluorescent probes include, but are not limited to, commercially available dyes, such as fluorescein, FITC (“fluorescein isothiocyanate”), R-phycoerythrin (“PE”), Texas Red, allophycocyanin, Cy5, Cy7, cascade blue, DAPI (“4′,6-diamidino-2-phenylindole”) and TRITC (“tetramethylrhodamine isothiocyanate”), and combinations of dyes, such as CY5PE, CY7APC, and CY7PE.

To image a tube and coated float system having undergone density-based separation, an analysis area is illuminated with one or more wavelengths of excitation light from a light source, such as red, blue, green, and ultraviolet. The excitation light is focused by an objective onto the analysis area, which is a space between the float and tube in which a target analyte may be retained or trapped. The different wavelengths excite different fluorescent probes, causing the fluorescent probes to emit light at lower energy wavelengths. A portion of the light emitted by the fluorescent probes is captured by the objective and transmitted to a detector that generates images, that are processed and analyzed by a computer or associated software or programs. The images formed from each of the channels can be overlaid when a plurality of fluorescent probes, having bound themselves to the target analyte, are excited and emit light. The light source and the objective may be separate pieces or may be one piece. The light source and the objective may be coaxial or may be located on different planes. The target analyte can then be characterized, and its location identified, based on the light emission(s) from the fluorescent probe(s) attached to the target analyte.

After undergoing appropriate processing, such as imaging, analysis, and detection, the target analyte may be collected, and once collected, the target analyte may be analyzed using any appropriate analysis method or technique, though more specifically intracellular analysis including intracellular protein labeling; nucleic acid analysis, including, but not limited to, nucleic acid microarrays; protein microarrays; fluorescent in situ hybridization (“FISH”—a tool for analyzing DNA and/or RNA, such as gene copy number changes); or branched DNA (“bDNA”—a tool for analyzing DNA and/or RNA, such as mRNA expression levels) analysis. These techniques use fixation, permeabilization, and isolation of the target analyte prior to analysis. Some of the intracellular proteins which may be labeled include, but are not limited to, cytokeratin (“CK”), actin, Arp2/3, coronin, dystrophin, FtsZ, myosin, spectrin, tubulin, collagen, cathepsin D, ALDH, PBGD, Akt1, Akt2, c-myc, caspases, survivin, p27^{kip}, FOXC2, BRAF, Phospho-Akt1 and 2, Phospho-Erk1/2, Erk1/2, P38 MAPK, Vimentin, ER, PgR, PI3K, pFAK, KRAS, ALKH1, Twist1, Snail1, ZEB1, Slug, Ki-67, M30, MAGEA3, phosphorylated receptor kinases, modified histones, chromatin-associated proteins, and MAGE. To fix, permeabilize, or label, fixing agents (such as formaldehyde, formalin, methanol, acetone, paraformaldehyde, or glutaraldehyde), detergents (such as saponin, polyoxyethylene, digitonin, octyl β-glucoside, octyl β-thioglucoside, 1-S-octyl-β-D-thioglucopyrano side, polysorbate-20, CHAPS, CHAPSO, (1,1,3,3-Tetramethylbutyl)phenyl-polyethylene glycol or octylphenol ethylene oxide), or labeling agents (such as fluorescently-labeled antibodies, Pap stain, Giemsa stain, or hematoxylin and eosin stain) may be used.

It should be understood that the method and system described and discussed herein may be used with any appropriate suspension or biological sample, such as blood, bone marrow, cystic fluid, ascites fluid, stool, semen, cerebrospinal fluid, nipple aspirate fluid, saliva, amniotic fluid, vaginal secretions, mucus membrane secretions, aqueous humor, vitreous humor, vomit, and any other physiological fluid or semi-solid. It should also be understood that a target analyte can be a cell, such as ova or a circulating tumor cell (“CTC”), a circulating endothelial cell, a vesicle, a liposome, a protein, a nucleic acid, a biological molecule, a naturally occurring or artificially prepared microscopic unit having an enclosed membrane, parasites, microorganisms, viruses, or inflammatory cells.

The foregoing description, for purposes of explanation, used specific nomenclature to provide a thorough understanding of the disclosure. However, it will be apparent to one skilled in the art that the specific details are not required in order to practice the systems and methods described herein. The foregoing descriptions of specific embodiments are presented by way of examples for purposes of illustration and description. They are not intended to be exhaustive of or to limit this disclosure to the precise faints described. Many modifications and variations are possible in view of the above teachings. The embodiments are shown and described in order to best explain the principles of this disclosure and practical applications, to thereby enable others skilled in the art to best utilize this disclosure and various embodiments with various modifications as are suited to the particular use contemplated. It is intended that the scope of this disclosure be defined by the following claims and their equivalents:

1. A float for separating a suspension suspected of containing a target analyte, the float comprising:
a main body; and
a coating applied to at least a portion of the main body, wherein the coating has an affinity for the target analyte.

2. The float of claim 1, wherein the coating attracts the target analyte.

3. The float of claim 1, wherein the coating forms a chemical bond with the target analyte.

4. The float of claim 1, wherein the coating is a changeable material that is changeable upon application of a stimulus.

5. The float of claim 4, wherein the stimulus further comprises one or more of thermal, electromagnetic, optical, light, or sound energy.

6. A float for separating a suspension suspected of containing a target analyte, comprising:
a main body; and,
a coating, wherein the float is sized to fit within a tube, and wherein the coating forms a sealing engagement between the float and the tube.

7. The float of claim 6, further comprising at least one structural element extending radially from the main body.

8. The float of claim 7, wherein the at least one structural element is coated with the coating.

9. The float of claim 8, wherein the coating is a changeable material that is changeable upon application of a stimulus.

10. The float of claim 9, wherein the stimulus further comprises one or more of thermal, electromagnetic, optical, light, or sound energy.

11. The float of claim 8, wherein the coating is an adhesive.

12. The float of claim 6, wherein the coating is applied to a portion of the main body.

13. The float of claim 12, wherein the coating is a changeable material that is changeable upon application of a stimulus.

14. The float of claim 13, wherein the stimulus further comprises one or more of thermal, electromagnetic, optical, light, or sound energy.

15. A system, comprising:
a float, comprising:
a main body, and,
a coating applied to at least a portion of the float, wherein the coating has an affinity for a target analyte; and,
a tube having an open end to receive the float and a suspension.

16. The system of claim 15, wherein a portion of the main body is coated with the coating.

17. The system of claim 15, wherein the coating attracts or chemically bonds with a target analyte.

18. The system of claim 15, the float further comprising at least one structural element extending radially from the main body.

19. The system of claim 18, wherein the at least one structural element is coated with the coating.

20. The system of claim 19, wherein the coating is capable of forming a seal between the float and the tube at a point at which the tube captures the float.
